(19) United States
(12) Patent Application Publication
(10) Pub. No.: US 2015/0213516 A1
(43) Pub. Date: Jul. 30, 2015

(54) COMPUTER SYSTEM FOR DISPLAYING VIDEO ADS ON WEB PAGES

(71) Applicant: Leo Jeremias, Los Angeles, CA (US)

(72) Inventor: Leo Jeremias, Los Angeles, CA (US)

(21) Appl. No.: 14/505,303

(22) Filed: Oct. 2, 2014

Related U.S. Application Data
(60) Provisional application No. 61/931,578, filed on Jan. 25, 2014.
(60) Provisional application No. 61/931,581, filed on Jan. 25, 2014.

(51) Int. Cl. G06Q 30/02

(52) U.S. Cl. CPC G06Q 30/0277

(57) ABSTRACT

A computer system for displaying web advertisements includes a processor and a non-transient memory device coupled to the processor and comprising a module for receiving a video advertisement and a module for receiving advertiser display preferences regarding the video advertisement from an advertiser. The memory further includes a player module and a playback script, wherein the playback script is called to serve as a frame from a web publisher's web page. The playback script causes the end user's browser to load the player module and the video, and the player module further comprises code for determining which video to playback based on at least bids and advertiser display preferences.

### CROSS-REFERENCE TO RELATED APPLICATIONS

This application claims the benefit of and priority to U.S. Provisional Application No. 61/931,578, filed Jan. 25, 2014, hereby incorporated by reference in its entirety. This application also claims the benefit of and priority to U.S. Provisional Application No. 61/931,581, filed Jan. 25, 2014, hereby incorporated by reference in its entirety.

### BACKGROUND

The present disclosure generally relates to the field of online advertising, particularly using the internet to deliver promotional marketing messages to webpage viewers. Conventional online advertising typically occurs through still images, interactive images, videos, click-through pages, and banner ads. The purpose of many online advertisements is to attract traffic to the advertiser's webpage by linking the advertisement to the advertiser's webpage. Advertisers can detect when a web user visits the advertiser's webpage by clicking on an advertisement on another webpage, commonly referred to as a “click-through”. In many cases, the advertiser pays the webpage that drives traffic to its own website an amount of money based on the number of click-throughs received from displayed advertisements.

Online advertising networks connect advertisers to webpages that wish to earn revenue from hosting advertisements. A key focus of online advertising networks is to maximize clickthroughs to advertiser webpages, thereby maximizing the revenue generated for websites that display advertisements.

Interoperability between different ad networks is typically limited. However, if a goal is to match the type of impression or website to an ad, it is unlikely a single ad network will be able to provide an ad for any possible impression. Many possible ad impression or click through opportunities are lost given this limitation of current ad servers. One challenge to providing interoperability is that some ad networks are automatic scheduling types and some are manual scheduling types. Automatic scheduling SDKs utilize ad fetching technologies where a single request to the ad server is made from the player. The SDK (not the player) keeps track of the playhead time and tells the player when to pause the real content and when to show the ad. Once the ad is shown, the SDK tells the player to resume the content video. Examples of automatic scheduling type SDKs include the Tremor SDK and Google's AdRules. ‘Manual’ scheduling SDKs are one where the player (i.e., a plug-in) keeps track of the playhead time of the true video content and then asks the SDK to make an ad call some time before the ad slot. The player plug-in then receives the response, interprets it, pauses the video content and cooperates with the SDK to show the ad. Examples of this type of system include Yume SDK and Vast SDKs.

### SUMMARY

This application generally relates to getting different ads (e.g., video ads from different ad networks) and to make them waterfall on the client side to maximize ad impressions and revenue for publishers. The inventor proposes a new extensible architecture allowing the integration of various SDKs, whether they are using automatic scheduling or manual scheduling technology. Since the plug-in is not always in charge of scheduling ads (e.g., when working with an ‘automatic scheduling’ type of SDK, the inventors propose an architecture for collecting all possible ad responses for a defined slot and displaying the winning ad. The architecture may advantageously unify the way SDKs interact with the plug-in, collect all ads for the same slot, apply the waterfalling engine, and then show the selected ad. In some embodiments the waterfalled ad plug-in is advantageously compiled directly into the player so that no additional file is required to load the waterfalled ad plugin.

A computer system for displaying web advertisements includes a processor and a non-transient memory device coupled to the processor and comprising a module for receiving a video advertisement and a module for receiving advertiser display preferences regarding the video advertisement from an advertiser. The memory further includes a player module and a playback script, wherein the playback script is called to serve as a frame from a web publisher's web page. The playback script causes the end user's browser to load the player module and the video, and the player module further comprises code for determining which video to playback based on at least bids and advertiser display preferences.

One embodiment relates to a method for displaying video advertisements on a webpage. The method includes receiving a video advertisement and advertiser display preferences regarding the video advertisement from an advertiser, determining if the video advertisement is compatible for displaying on a webpage and converting the video advertisement into a compatible format if necessary, receiving webpage display preferences regarding video advertisements from a webpage publisher, matching the video advertisement with a webpage publisher for display on the webpage publisher's webpage based on the advertiser display preferences and the webpage display preferences, and displaying the video advertisement on the publisher's webpage.

Another embodiment relates to the advertiser display preferences and webpage display preferences including whether the video advertisement should play sound.

Another embodiment relates to the advertiser display preferences and webpage display preferences including the screen position where the video advertisement should play.

Another embodiment relates to the advertiser display preferences and webpage display preferences including whether a webpage viewer can access content on the webpage while the video advertisement is playing.

Another embodiment relates to the advertiser display preferences including information relating to a desired viewing audience.

Another embodiment relates to displaying the video advertisement on the publisher's webpage as a pop-up window.

Another embodiment relates to requiring the video advertisement to be viewed for at least five seconds before a webpage viewer can access the webpage's content.

Another embodiment relates to requiring the video advertisement to be viewed in its entirety before a webpage viewer can access the webpage's content.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic diagram of an advertising exchange system for displaying video advertisements on a webpage according to one embodiment.

FIG. 2 is an illustration of a video advertisement being displayed on a webpage according to one embodiment.

FIG. 3 is a schematic diagram of an advertising exchange system for displaying video advertisements according to another embodiment.

FIG. 4 is a diagram of a method for displaying video advertisements on a webpage according to one embodiment.

FIG. 5 is a diagram of a method for displaying video advertisements on a webpage according to another embodiment.

### DETAILED DESCRIPTION

The systems and methods according to the present invention display videos on a webpage. In some embodiments, the videos may overlay a visited webpage and “pre-roll” before a webpage visitor has full access to the contents of the webpage. In other embodiments, the videos is displayed in a pop-up window; in other embodiments, the videos are included within the webpage as an inline video. In many cases, visitors cannot ignore the advertisement because the advertisement must be fully viewed, or in some cases partially viewed, before content on the underlying webpage is revealed or before content on the underlying webpage is displayed at all. Accordingly, requiring webpage visitors to view the advertisements provides advertisers with a higher degree of advertising accountability, more engagement with the users, and provides advertisers with further opportunities to engage webpage visitors after the mandatory viewing period expires.

In the systems and methods described herein, a website owner may place a video advertisement in his or her webpage. JavaScript code may be used to request video advertisements to be provided to the webpage. In one embodiment, the video advertisement may be displayed by creating and/or populating an iframe (i.e., an inline frame of a webpage). The video can thus be integrated with the webpage. In other embodiments, the video advertisement may be displayed as a pop-up video. The systems and methods herein may further include any method for selecting the video advertisement to display (e.g., allowing advertisers to submit bids for providing their video advertisements to the webpage).

In some embodiments, the video player is a JavaScript player that includes elements of Flowplayer, JW player, Yume SDK players, or other types of video players. The video player may call functions that are embedded in or included in webpages and that interact with the Document Object Model of the page. The video player code may run locally in a user's browser rather than on a remote server. In one embodiment, page elements may be faded out while the pop-up video player plays the advertising video. In other embodiments, the video player may pop up either on a window of a webpage, in a corner of a webpage, or in the interstitial space of a webpage. In some embodiments, the original content of the webpage may be accessible to the webpage visitor during playback of the video advertisement. In other embodiments, only a portion of the original content may be accessible to the webpage visitor during playback of the video advertisement. In yet other embodiments, all of the original content may be accessible to the webpage visitor during playback of the video advertisement.

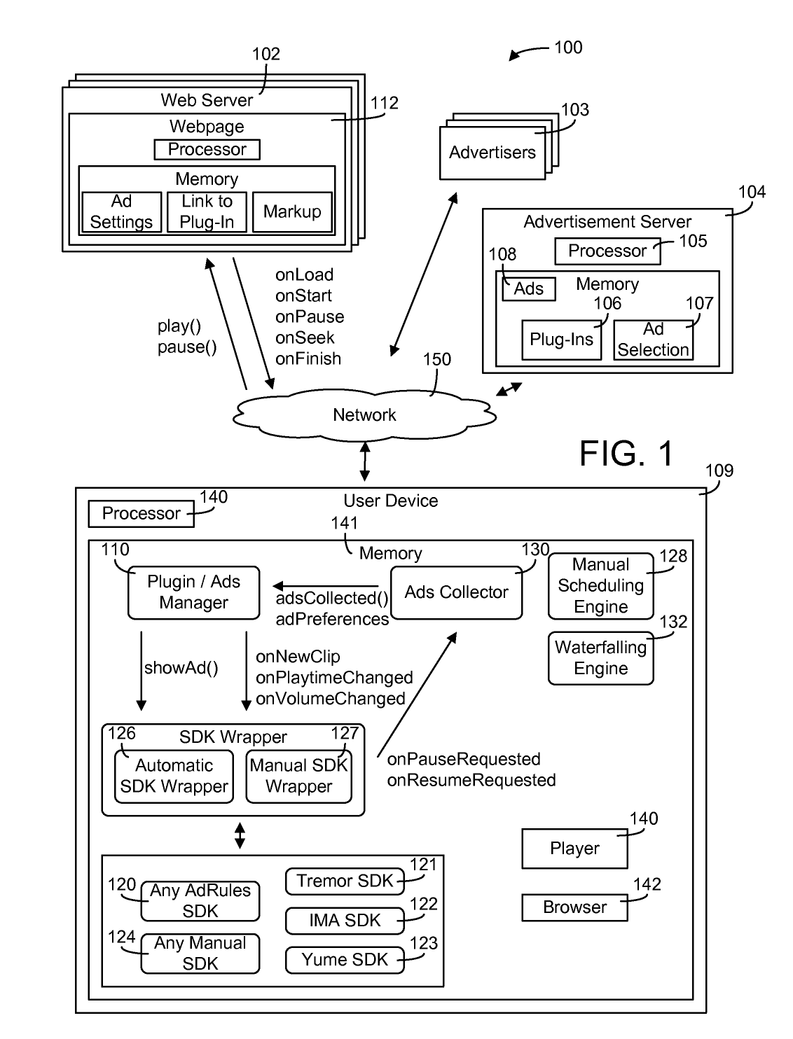

Referring now to FIG. 1, an advertising exchange system 100 for displaying video advertisements on a webpage is shown according to one embodiment. The advertising exchange system 100 may generally include a plurality of web servers 102 and advertisers 103, an advertisement server 103, and a user device 109. The user device 109 may be a computer, laptop, tablet, mobile phone, or any other device configured to display online content. The advertisers 103 may provide advertisements for display on the user devices 109. The web servers 102 may provide webpages for display on the user device 109. Each webpage may generally include markup language for formatting the webpage, a link to a plug-in for the webpage, and various advertisement settings (i.e., settings relating to the type of advertisement that can be displayed on the webpage). The advertisement server 104 may generally be configured to select and provide advertisements for display on the webpages viewed by a user of the user devices 109. Various embodiments of system 100 may exist that include additional components, fewer components, or a combination of the components of FIG. 1.

The user device 109 may generally include a browser 142 configured to display webpages. The browser 142 may be configured to play video on the webpages on the user device 109 on a player 140, including video advertisements as described in the present disclosure. The browser 140 may indicate to other components of the user device 109 the interaction between the user and the video. For example, the indication may include noting when the video is loaded, started, or finished, if the user is seeking in the video, or if the user paused the video. In some embodiments, the advertisement is provided on the user device 109 such that the regular content on the webpage on the browser is inaccessible to the user if the user has not finished watching a video or has paused the video. This may affect the user's ability to use the browser 112. Settings provided by the advertisement server 104 may be used to configured the browser 142 and user device 109 accordingly.

The advertisement server 104, and more particularly an advertisement selection module 107, may generally be configured to select one or more potential advertisements for display on the browser 142 of the user device 109. The advertisement selection module 107 may be generally configured to collect advertisements from a plurality of sources via advertisers 103 and store the advertisements 108 in a memory of the advertisement server 104. The advertisement server 104 further includes a plurality of plug-ins 106 required to display the advertisements. The advertisement server 104 may be configured to provide the selected video advertisement and associated plug-ins to the user device 109 in response to requests from the user device 109.

The user device 109, and more particularly the memory 141 of the user device 109, may include a plurality of SDK plugins, SDK wrappers, and scheduling engines to accommodate the various formats and types of video advertisements that may be displayed on the user device 109. These plug-ins, SDKs or other modules may be contained within a plug-in package downloaded from, e.g., plug-ins 106. As illustrated in FIG. 1, the web page served by web server 102 can include a link to a plug-in (directly or indirectly). The link to the plug-in may be a script configured to load a mark-up document into a frame or other portion of the web page. The link (or the additional markup document containing the link to the plug-in) may cause the plug-in to be loaded from advertisement server 104. The plug-in, as will be described later in this application, can include computer code for evaluating advertisement options and for determining which of a plurality of possible advertisements to display.

Memory 141 is shown to include an AdRules SDK 120, a Tremor SDK 121, a IMA SDK 122, and a Yume SDK 123. Of course, any type of automatic or manual SDK plugin may be included. Each SDK plugin 120-124 may be configured to request and play video of a particular format or advertising ad supplier. As noted above, some SDKs (e.g., Tremor, AdRules), are automatic scheduling SDKs while other SDKs (e.g., Yume) are manual scheduling SDKs. Memory 141 may further include a SDK wrapper, such as an automatic SDK wrapper 126 or manual SDK wrapper 127, configured to simplify the functionality of the various SDKs. Memory 141 may further include a manual scheduling engine 128 or other scheduling engine configured to provide a schedule for displaying advertisements on a webpage. The SDK wrapper may be called by the plug-in to gather potential advertisements for display from each of the available sources and/or SDKs. Results received, which may be pulled from the advertisement server 104 and its ad selector 107, can be collected by the ads collector 130.

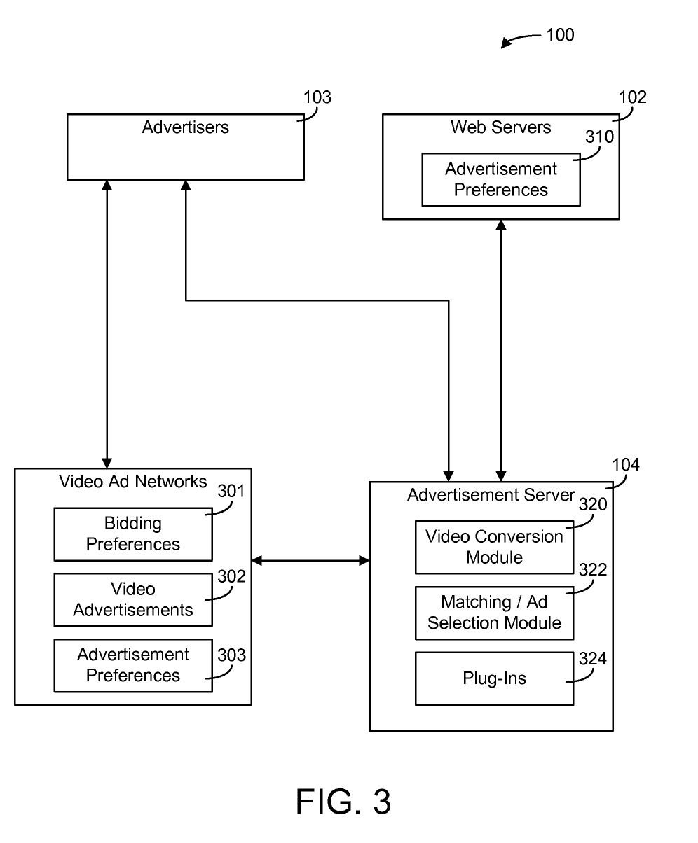

Memory 141 is shown to include an ads collector 130. The ads collector 130 may generally be configured to, upon request from an SDK wrapper, retrieve advertisements from the advertisement server 104 that the advertisers wish to display on a webpage. The advertisement server 104 selects advertisements for display on the user device 109 based on the content of the advertisements, bids submitted by the advertisers 104 for displaying the ads on a webpage, a CPM rate or other metric indicative of how a user might interact with the advertisement, or a combination thereof. Memory 141 then generally formats the video advertisements for display via the various SDKs. An example of the ad selection process is described in greater detail in FIG. 3. In some embodiments, a new set of ads may be collected in response to a video pausing or being resumed (e.g., via onPauseRequested or onResumeRequested event). In other embodiments, ads may merely be collected when the page or plug-in is initially loaded. In yet other embodiments, ads are collected on a regular basis or if the user continues playing new videos. For example, an advertisement video may be played at the beginning of playing a new regular content video the user wishes to view.

In one embodiment, system 100 utilizes JavaScript (e.g., embedded in the web page) to display video advertisements on webpages. In one embodiment, an example of code used by system 100 to display video advertisements is shown as follows:

```
function( ){
      var i, frames, frame, ww, hh;
      frames = document.getElementsByTagName(“iframe”);
      for (i = 0; i < frames.length; ++i)
            {
            frame = frames[i];
            ww = frame.clientWidth; hh = frame.clientHeight;
            if(ww == ‘300’ && hh == ‘250’)frame.src =
            ‘http://ads/video_loader.html’;
            }
};
```

Referring to the above code, a set of web page frames are collected for those page frames tagged with “iframe”. iframe, or inline frames, allow for the tagging of parts of an existing webpage, such that the video can be integrated with the webpage. Referring further to the code presented above, for each identified frame tagged with iframe, the width and the height of the frame are checked. If requirements are met, then the frame source is set to a page that can load in the frame. The page loaded in the frame may be prepared specifically for the requesting web page. Thus, it may include a plug-in specific to the web page, settings or script portions specific to the web page, or other details as specified by the web page owner regarding how the ads are to be displayed and selected. The source may be a URL specific to the webpage (e.g., a link for a certain website ID). In an exemplary embodiment, the frame loaded also loads the plug-in package and the plug-in package uses embedded code to select the video for display from a plurality of possible videos. This can be conducted using waterfalling engine 132 discussed below.

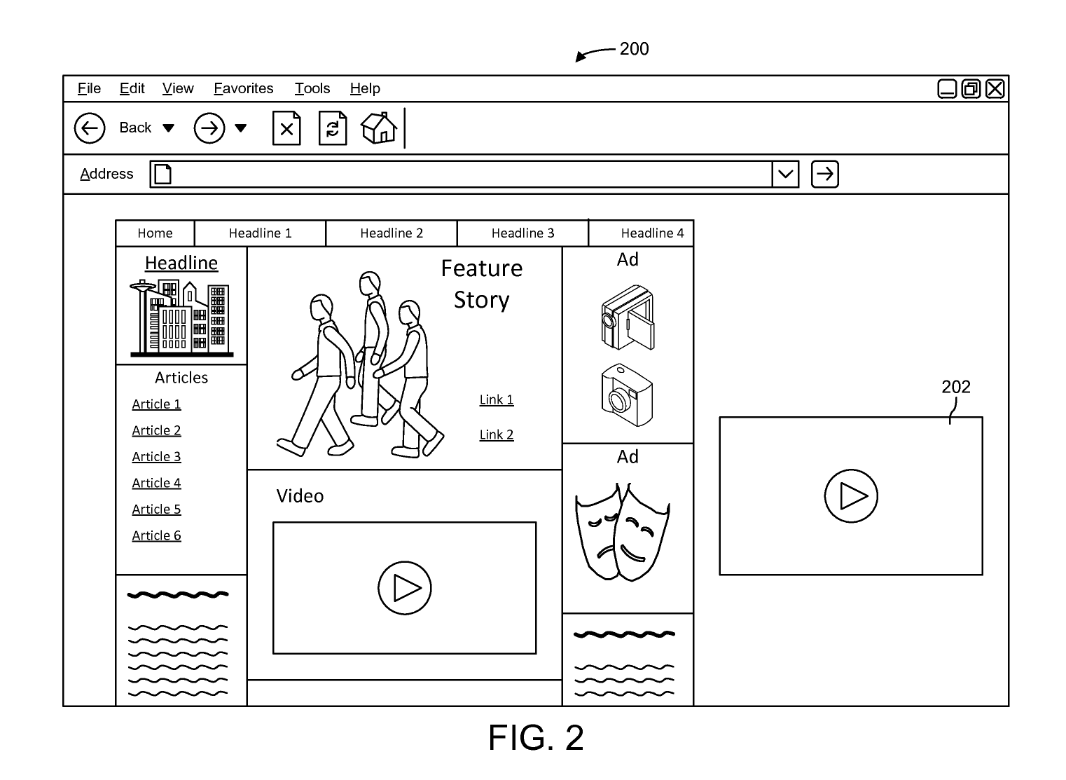

Referring also to FIG. 2, an example webpage 200 is shown. The webpage 200 is shown to include a video 202. The video 202 is integrated with the webpage 200 in an inline frame. The video 202 may be configured to play upon loading of webpage 200, or during the loading of the other webpage elements, and the systems and methods described herein may be used to disable the ability to access the rest of the content on the webpage 200 until some or all of the video 202 has played. In other embodiments, the video 202 may be a pop-up video instead of within a frame of the webpage 200.

Referring now to the architecture for allowing the integration of multiple video ad servers, certain elements of the system 100 may integrated in a configuration of Flowplayer (e.g., the “clip” configuration of Flowplayer). In one embodiment, an advertisement configuration is defined for each SDK. For example, for automatic scheduling SDKs (e.g., Tremor, or Google when used with AdRules), all required parameters are defined according to the SDK documentation; for manual scheduling SDKs (e.g., Yume, or Google used without AdRules), an array of objects containing all required parameters is specified and the time the advertisement should be shown is specified. In one embodiment, the waterfall type is defined. The waterfall type may generally indicate a type of policy for how to select video advertisements for display (i.e., the first video advertisement available gets selected, an advertisement from a SDK with a greater weight gets selected, etc.). For example, it may not be desirable to choose to display the first video advertisement received from a SDK. A waterfall policy is applied to allow other SDKs to provide their own video advertisements so that the best one is chosen for display. In other words, the user device 109 may be configured to select an advertisement for display based on advertisements received from the various SDKs via the various advertisers during a set period of time (e.g., 2 seconds). The user device 109 is shown to include a waterfalling engine 132 for such activity as described below. The waterfalling engine 132 may be contained within the video player plug-in and thus self-contained and transparent to the end user (e.g., the only plug-in loading is the expected video player).

In one embodiment, a single advertisement object is defined on the Clip object and composed by several other objects to configure advertisements. In one embodiment, each SDK has its own object inside the advertisement object identified by the SDK ID. Furthermore, waterfalling options (e.g., waterfallWeight used along with a Weight Waterfall policy) are selected within the SDK configuration object. For example, if the SDK is operating in an automatic scheduling mode, a single “request” object will be defined containing all SDK parameters. An advertisement array may be defined if the SDK is operating in a manual scheduling mode. In one embodiment, each entry is represented as an object with a “time” field (e.g., 0 for preroll, −1 for postrolls and any other positive integer for midrolls) and a “request” object containing all the SDK parameters to be used when the system actually requests a video for display from the appropriate advertiser. In one embodiment, an example of a configuration code used by system 100 is shown as follows:

```
clip: {
      url: ‘your video url’,
      ads : {
            waterfalling: {
                  type: ‘weight’, // or ‘first’
                  forecastedSlots: [0, 60] // optional, needed for
                  emptySlot event
                  ignoreUnforcastedSlots: true
            },
      tremor: {
            waterfallWeight: 100,
            request: {
                  progId : 456,
                  videoId : 7879,
                  ...
            }
      },
      dfp: {
            waterfallWeight: 500,
            request: {
                  adTagURL: ‘AdRule adTagURL’
            }
      },
      adsense: {
            waterfallWeight: 10,
            ads: [{
                  time: 0,
                  request: {
                        adType: ‘video’
                  }
            },{
                  time: 60,
                  request: {
                        adType: ‘video’
                  }
            }]
      },
      yume: {
                  waterfallWeight: 0,
                  ads: [{
                        time: 0,
                        request: {
                              channel: 123,
                              id: 4498,
                              ...
                        }
                  },  {
                        time: 60,
                        request: {
                              channel: 123,
                              id: 4498,
                              ...
                        }
                  }]
            }
      }
}
```

In the above code, during a waterfalling process, the user device 109 (more specifically, the waterfalling engine 132 or another part of the plug-in received by the user device) can use the configuration parameters setup via the above code to drive the waterfalling process and to appropriately communicate with the SDK (e.g., the SDK whose video will be shown as a result of the waterfalling logic). In this manner, a video advertisement for display from a plurality of SDKs (i.e., Tremor, DFP, AdSense, and Yume) may be presented to a website. The configuration code includes the type of advertisement requested (which SDK or ad provider), a weight associated with the SDK, and a time variable indicative of when to play that type of ad. For example, the time variable may indicate when a certain SDK is to be used as a pre-roll video source. The advertisement server may use such information to select the best advertisement to display in a response to a request for an inline video from the browser (triggered via the short iframe-related code above).

As shown, the configuration file can contain a waterfalling object containing a waterfalling policy and options, for example, a type or assigned weight that determines the ordering, stacking or waterfalling of advertisements. In one embodiment, the waterfalling object may be adjusted based on a classification of advertisement information from direct sale advertisers, publisher representation advertisers, advertising networks, and remnant providers. The policies and options for the waterfalling may include optional parameters, conditional parameters, or Boolean data types, among others.

The user device 109, advertisement server 104, and web server 102 may include any type of machine-readable storage device capable of storing video advertisements, advertiser preferences, and display preferences, or program instructions for displaying video advertisements. For example, each is shown to include a processor (e.g., processor 140) and a memory (e.g., memory 141). A storage device may be, for example, a non-transitory machine-readable media for carrying or having machine-executable instructions or data structures stored thereon. Such machine-readable media may be any available media that may be accessed by a general purpose or special purpose computer or other machine with a processor. By way of example, such machine-readable media may comprise random access memory (RAM), read only memory (ROM), erasable programmable read only memory (EPROM), electrically erasable programmable memory (EEPROM), CD-ROM or other optical disk storage, magnetic disk storage or other magnetic storage devices, or any other medium which may be used to carry or store desired program code in the form of machine-executable instructions or data structures and which may be accessed by a general purpose or special purpose computer or other machine.

The web server 102, advertisers 103, advertisement server 104, and user device 109 may communicate with one another via a network 150. The network 150 may be any type of network (e.g., LAN, WAN, the Internet, etc.) over which the various components of advertising exchange system 100 may communicate. It should be appreciated that each of web server 102, advertisers 103, advertisement server 104, and user device 109 include a processor, memory for storing executable program code for accomplishing the respective activities described herein, and communications electronics coupled to the processing system for conducting the communication with the rest of the networked system.

Referring now to FIG. 3, a diagram of the advertising exchange system 100 displaying the data flow between the web server 102, advertiser 103, video ad networks, and advertisement server 104 is shown according to one embodiment. Advertisers 103 may make bids to display their advertisements on the webpages of publishers through the advertising exchange system 100. For example, advertisers can bid to display their advertisements on webpages through Yume or Adap TV using Video Ad Serving Template tag compliance. Advertisers 103 may utilize multiple licensed platforms. For example, advertisers may bid on a run of network advertisements or advertisers may bid on specific web pages or specific advertisements. Advertisers 103 may include bidding preferences 301 that may indicate such information. For example, bidding preferences 301 may include how much a bid should be for a particular advertisement, when or when not to submit a bid for an advertisement based on the platform or website the advertisement is to be presented, or otherwise. In one embodiment, the bidding preferences 301 may reflect the likelihood the advertisement is effective (i.e., if a user is more likely to view and interact with the advertisement, the bid may increase).

The advertisement server 104 receives video advertisements 302 uploaded to the system by advertisers 103. After a video advertisement is uploaded, the video is converted into a compatible format for displaying on a webpage. The advertisement server 104 is shown to include a video conversion module 320 for converting the video advertisement into a format compatible with a webpage (if necessary). In one embodiment, advertisers 103 upload a video advertisement into the advertisement server 104 or another system, such as Yume or AdapTV. After uploading is complete, the video is converted into a VAS tag format. After conversion to the VAS tag format, the converted video is able to be displayed on webpages. In one embodiment, advertisement server 104 may then present the video advertisement using a JavaScript code based on the predefined preferences of the advertisers and publishers. For example, referring to the code above, the line of code that specifies an iframe format is used to retrieve video advertisements compatible with an inline frame of the webpage.

The advertisement server 104 receives inputs from web servers 102 wishing to display advertisements on their webpages and inputs from advertisers 103 wishing to display their advertisements on publisher webpages. Web servers 102 and advertisers 103 both submit advertisement preferences 310, 303 regarding preferred features relating to the displaying of video advertisements. For example, preferred features may include whether advertisements displayed on a webpage may or may not play sound during playback of the video. As another example, preferred features may include the volume of the sound played during playback of the video (e.g., publishers and/or advertisers may choose to play back advertisements at a higher sound level than the webpage's own configured volume level). As another example, preferred features may include whether a webpage visitor has the capability to skip the advertisement or to prematurely close the advertisement before the video advertisement finishes playing (e.g., the user may have an option to close the video advertisement after viewing the video for 5 seconds, 10 seconds, etc., or may not be able to close the video). As another example, preferred features may include the size of the video advertisement or the screen placement of the video advertisement (e.g., the video advertisement may only be displayed in an area on the webpage that does not cover any content, such as the placement illustrated in FIG. 2). In one embodiment, the advertisement may also play via a pop-up window in the middle of the page via a slider coming up from the bottom of the page as well as the side in an area that does not interfere with other content. As another example, preferred features may include the webpage user's accessibility to content while the video advertisement is playing. As another example, preferred features may include the frequency at which video advertisements will play during a specific user's visit to a webpage. As another example, preferred features may include whether to allow users to click on any link or otherwise interact with the webpage before the video advertisement is finished (for example, the links as shown in FIG. 2). As another example, preferred features may include whether to have a user view a video advertisement every time the user clicks on a link or accesses a new page linked from the main webpage screen, or on a regular or irregular schedule (e.g., every five new pages, every ten new pages, etc.).

In some embodiments, the advertisement server 104 receives further inputs from web servers 102 and advertisers 103. For example, advertisers 103 can choose the amount they are willing to pay to have the video advertisement displayed based on website traffic, and may provide the information as part of bidding preferences 301. For example, advertisers can indicate that they will pay up to $5.00 for every one thousand viewers that are directed to their webpage, otherwise referred to as a cost per impression or CPM. Advertisers may also choose to pay a higher rate for clickthroughs from specific webpages. For example, an advertiser in the business of wholesale food may indicate that they will pay more for traffic directed to their site from other food-related webpages as opposed to traffic directed from educational webpages. In some embodiments, advertisers can bid to display their video advertisements on specific webpages or on webpages in a general category.

The advertisement server 104 is shown to include a matching module 322. The matching module 322 receives the inputs from web servers 102, the video ad networks, and advertisers 103 and matches advertisers (or their preferences as stored with an ad network) with publishers. The matching module 322 may be a real-time bidding system that automatically selects and plays video advertisements on a webpage based on specified criteria. For example, in one embodiment, the matching module 322 may always select and play video advertisements with the highest CPM rate on a particular webpage. The matching module 322 may be configured to select a video advertisement for display based on a request from a webpage. For example, for a webpage with an inline frame (“iframe”) for displaying video advertisements, a single line of JavaScript (as described above) may be used to request a video advertisement for the inline frame.

In one embodiment, the matching module / ad selection module 322 may be as described with reference to FIG. 1 and configured to select video advertisements for consideration by a requesting plugin for display on a certain webpage, based on a scoring formula.

In one embodiment, the matching module 322 may be configured to retrieve video advertisements from different video advertising networks. For example, in some instances multiple advertising networks are scanned to find an advertisement with the most potential to result in a clickthrough. In other embodiments, multiple advertising networks are scanned to find the next available advertisement with the highest CPM or by using other criteria. In one embodiment, the code (e.g., the JavaScript code as described above) remains dormant until it is executed by the browser as a part of the plug-in. Then attempting to retrieve an advertisement by calling all networks (via the various SDK plug-ins in the video player). Plug-ins 324 for reception and execution by the browser and processor of the user's device can be stored on the advertisement server. The computer architecture described herein can be used to create a new type of ad unit for consumption by a content provider. The content provider (web server owner) may subscribe with the advertisement server 104 and know that they are receiving the best matches or ad rates given their preferences, and without selecting only one video ad provider. The advertisers can subscribe with the advertisement server 104 and know that they are able to have their videos on a variety of ad networks displayed for viewing depending on which ad network is faster or preferred by the end user (web site owners).

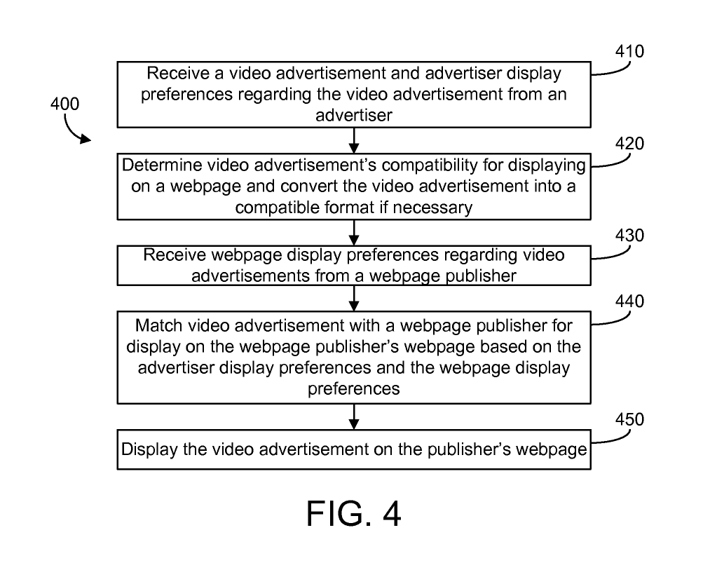

Referring now to FIG. 4, a method 400 is shown according to one embodiment. For example, the method 400 may be implemented by the user device 109 as described above. The method 400 includes receiving a video advertisement and advertiser display preferences regarding the video advertisement from an advertiser (step 410). The video advertisement's compatibility for displaying on a webpage is determined and the video advertisement is converted into a compatible format if necessary (step 420). Webpage display preferences regarding video advertisements are received from a webpage publisher (step 430). The video advertisement is matched with a webpage publisher for display on the webpage publisher's webpage based on the advertiser display preferences and the webpage display preferences (step 440). The video advertisement is then displayed on the publisher's webpage (step 450).

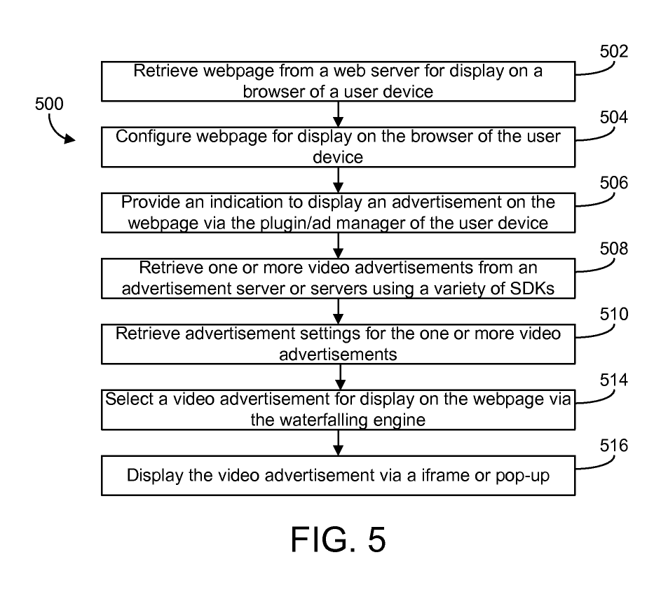

Referring now to FIG. 5, a method 500 for displaying video advertisements on a webpage is shown according to another embodiment. The method 500 may be implemented by, for example, a user device 109 and the various modules of memory 141. The method 500 includes retrieving a webpage from a web server for display on a browser of a user device (step 502). For example, a user on the user device may type in a URL, select a link, or perform another action to cause the retrieval of the webpage from the web server. The retrieval of the webpage may include the retrieval of the markup language for the webpage and a link to a plug-in for the webpage. The plug-in may be used to display a video advertisement on the webpage. The retrieval of the webpage may include an indication if the webpage includes an iframe, as described above.

The method 500 further includes configuring the webpage for display on the browser of the user device (step 504). The method 500 further includes providing an indication to display an advertisement on the webpage (step 506). The indication may be provided via a script such as the iframe related script above that requests an additional URL from, e.g., an advertisement server. This URL may load a plug-in. The plug-in loaded by the browser may include a plugin-ads manager 110 configured to determine that an advertisement should be shown on the webpage based on the webpage advertisement settings.

The method 500 further includes retrieving one or more advertisements from an advertisement server (step 508). In some embodiments, the user device, and more particularly, a SDK wrapper, may determine based on the retrieval of the webpage at step 502 that a video advertisement should be provided on the webpage, and may initiate the request for the ads collector of the user device. For example, the SDK wrapper may send a pause or resume request to the ads collector to initiate the retrieval of video advertisements. The request may include advertisement settings based on browser settings and settings retrieved from the web server to determine video advertisements eligible for display on the webpage, and such advertisements may be retrieved from the advertisement server at step 508. Such advertisement settings may include, for example, if the advertisement has sound, how long the advertisement is, display settings for the advertisement, the type of video format, etc. At step 508, the user device may be configured to just retrieve a first video advertisement from the advertisement server, a number of video advertisements provided within a certain time period (e.g., two seconds), or in any other way. In some embodiments, the advertisement server may be configured to select eligible advertisements to be presented to the user device at step 506, as described with respect to FIG. 3. At step 508, the retrieving of advertisements may be made based on a manual scheduling engine (e.g., manual scheduling engine 128 of FIG. 1) for displaying advertisements on the webpage.

The method 500 further includes retrieving advertisement settings for the advertisements (step 510). For example, in some embodiments, the webpage may be configured to not allow browsing of the webpage, or restrict browsing for some portions of the webpage, until a video advertisement has finished or partially finished playing. Further, the advertisement settings may include if the video advertisement is displayed with sound, if the video advertisement can be paused or seeked, or if the video advertisement may be interacted with by a user in any other way.

As described above with reference to FIG. 1, a plurality of SDKs may be provided for formatting a plurality of video advertisements in different formats. At step 510, a plugin/ads manager 110 of the user device may receive the advertisements retrieved by the ads collector (e.g., using a plurality of SDKs for a plurality of video networks).

The method 500 further includes selecting a video advertisement for display on the webpage (step 514). The selection of the video advertisement may be based on the webpage advertisement settings and the advertisement settings retrieved at step 510. In one embodiment, step 514 includes using a waterfalling engine to determine which advertisement to display. For example, the waterfalling engine 132 may select a video advertisement for display among all video advertisements retrieved by the ad collector 130 and formatted by an SDK, as described above with reference to FIG. 1. The method 500 further includes displaying the video advertisement on the webpage on the browser (step 516). Step 516 may further include limiting or removing the ability of a user to browse the webpage during playback of the advertisement, or any limiting any other browser functionality as described above. Step 516 may include either providing the video advertisement in an iframe or providing the video advertisement as a pop-up.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A computer system for displaying video advertisements on web pages, comprising:
a processor; and
a non-transient memory device coupled to the processor, wherein the memory device comprises a web server having a web page markup document, wherein the web page markup document comprises a site evaluation module to determine whether there are any locations on the website for the display of a video ad, and wherein the evaluation module calls a document that loads a video plug-in and the video ad, the video plug-in capable of playing back video from multiple video ad networks.

2. The computer system of claim 1, further comprising:
an ad server wherein advertisers can use graphical user interfaces to bid on placement of their ads on the web page and other pages from other publishers.

3. The computer system of claim 2, wherein the ad server requires the advertisers to select an advertising rate, and wherein the ad server causes the document that loads the video plug-in to select an ad with a relatively high advertising rate from the pool of possible ads.

4. The computer system of claim 1, wherein the web page markup document is configured to overlay the video on the web page and to play through the entire video prior to displaying the full website content for viewing.

5. The computer system of claim 1, wherein the advertisers can choose to only play ads at specific volumes.

6. A computer system, comprising:
a processor;
a non-transient memory device coupled to the processor and comprising a plurality of modules, which are executable by the processor, including:
a module for receiving a video advertisement, which when executed, requests and receives the video advertisement from an advertisement network; a module for receiving advertiser display preferences regarding the video advertisement, which when executed retrieves the advertiser display preferences regarding the video advertisement from an advertiser; and
a player module, including a playback script, which when executed:
calls the playback script to serve as a frame from a web publisher's web page;
causes the end user's browser to load the player module and a video;
identifies an advertising time slot occurring at a future time
requests potential advertisements for display at the advertising time slot from both an automatic scheduling type advertising network and a manual scheduling type advertising network;
selects an advertisement to display, from the received potential advertisements for display, based on at least bids and advertiser display preferences; and
displays the selected video;
wherein the player module is compatible with both automatic scheduling type advertising networks and manual scheduling type advertising networks.

7. The computer system of claim 6, wherein the player module includes an SDK wrapper, which when executed, requests and receives potential advertisements for display from both an automatic SDK of the automatic scheduling type advertising network and a manual SDK of the manual scheduling type advertising network.

8. The computer system of claim 6, wherein the player module includes a waterfalling engine configured to determine which video to playback, and which, when executed:
communicates with a plurality of different advertising SDKs including at least one automatic SDK of the automatic scheduling type advertising network and one manual SDK of the manual scheduling type advertising network;
provides the plurality of SDKs at least one of a type of video advertisement requested, a weight associated with the type of SDK, or a time variable; and
requests advertisement videos from a plurality of advertising networks iteratively until an advertisement for video playback is selected based on at least bids and advertiser display preferences.

9. The computer system of claim 6, wherein the automatic type scheduling advertising network and an associated SDK included in the player module are configured to track a playhead time and pause content to insert one of a plurality of previously retrieved video advertisements, and wherein the manual scheduling type advertising network and an associated SDK included in the player module are configured to request a video advertisement before an advertising time slot.

10. The computer system of claim 6, wherein the advertiser display preferences include at least one of a volume at which the video advertisement plays, a screen position at which the video advertisement plays, whether a webpage viewer can access content on the webpage while the video advertisement is playing, or a desired viewing audience.

11. The computer system of claim 6, further comprising:
an ad server wherein advertisers can use graphical user interfaces to bid on placement of their ads on the web page and other pages from other publishers.

12. The computer system of claim 12, wherein the ad server requires the advertisers to select an advertising rate, and wherein the ad server causes the document that loads the video plug-in to select an ad with a relatively high advertising rate from the pool of possible ads.

13. The computer system of claim 6, wherein a web page markup document is configured to overlay the video advertisement on the web page and to play through the entire video advertisement prior to displaying the full website content for viewing.
